(19) United States
(12) Patent Application Publication
(10) Pub. No.: US 2014/0159512 A1
(43) Pub. Date: Jun. 12, 2014

(54) STATOR STRUCTURE

(71) Applicant: INDUSTRIAL TECHNOLOGY RESEARCH INSTITUTE, Hsin-Chu (TW)

(72) Inventors: Min-Fu Hsieh, Tainan (TW); Wan-Yu Wu, Tainan (TW); Hui-Chun Ho, Hsinchu County (TW); Yee-Pien Yang, Taipei (TW)

(73) Assignee: INDUSTRIAL TECHNOLOGY RESEARCH INSTITUTE, Hsin-Chu (TW)

(21) Appl. No.: 13/864,757

(22) Filed: Apr. 17, 2013

(30) Foreign Application Priority Data
Dec. 7, 2012 (TW) 101146087

(51) Int. Cl. H02K 1/12

(52) U.S. Cl. CPC H02K 1/12
USPC 310/12.24

(57) ABSTRACT

A stator structure includes a main body having multiple frames each having an arc panel, a main tooth, at least one secondary tooth, at least one main coil and at least one secondary coil. The main tooth and the secondary tooth are disposed at one face of the arc panel. The main coil is installed at the main tooth, and the secondary coil is installed at the secondary coil. A rotor is penetrated through the stator structure. The frames are in a multi-layer circular arrangement at the rotor, and a dislocation angle exists between the frame at any layer and the frame at the neighboring layer.

### CROSS-REFERENCE TO RELATED APPLICATIONS

This application claims the benefit of Taiwan application Serial No. 101146087, filed Dec. 7, 2012, the disclosure of which is incorporated by reference herein in its entirety.

### TECHNICAL FIELD

The disclosed embodiments relate in general to a stator structure, and more particular to a stator structure for a linear motor.

### BACKGROUND

Electric automobiles, powered by battery devices, are eco-friendly by being zero air pollution and low-noise. However, current batteries for electric automobile suffer from inadequate energy densities and high costs, resulting in unsatisfactory endurance of electric automobiles. The batteries are further disadvantaged by having a lengthy charging period as well as scarce resources of charging equipments.

Based on the above factors, popularity of electric automobiles is quite low. Thus, certain electric automobiles are equipped with a mileage extender for overcoming the above setbacks.

A mileage extender can be a linear motor, which is capable of simultaneously implementing a linear motor and a linear generator while also satisfying requirements of a high power density and a high specific power. Yet, current linear motors are designed based on considerations of stacked silicon steel plates, such that only a two-dimensional stator structure can be used since the design is limited by process techniques. Moreover, not only an effective coil length cannot be reduced due to winded coils but also the large amount of copper lines used result in copper loss. Consequently, an overall efficiency is degraded. Therefore, there is a need for a solution for improving the foregoing stator structure.

### SUMMARY

According to one embodiment, a stator structure is provided. The stator structure comprises: a main body, comprising a plurality of frames each having an arc panel, at least one main tooth, at least one secondary tooth, at least one main coil, and at least one secondary coil. The main tooth and the secondary tooth are disposed at one side of the arc panel. The main coil is installed at the main tooth, and the secondary coil is installed at the secondary tooth.

A rotor is penetrated through the stator structure. The frames are in a multi-layer circular arrangement at the rotor, and a dislocation angle is present between a frame at any layer and the frame at the axially neighboring layer.

### BRIEF DESCRIPTION OF THE DRAWINGS

FIG. 1 is an elevational view of a stator structure according to one embodiment.

FIG. 2 is a partial schematic diagram of a stator structure according to one embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

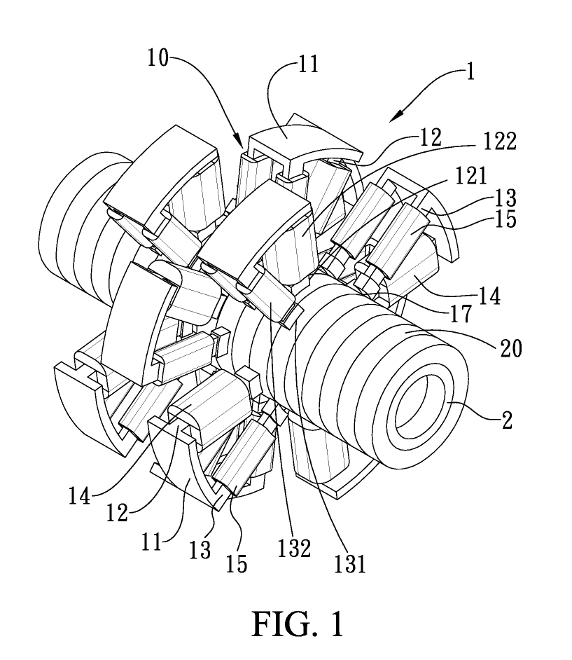

FIG. 1 shows a stator structure according to one embodiment. The stator structure is made from soft magnetic composites (SMC) by a powder metallurgy technique, or is formed from cutting a silicon steel block. The stator structure is suitable for applications of a linear motor, a linear compressor of a power tool, a power motor of a pump and a linear power generator of a power tool.

The stator structure comprises a main body 1.

The main body 1, being a circular body, comprises a plurality of frames 10 in a multi-layer circular arrangement at a rotor 2. A dislocation angle is present between a frame 10 at any layer and the frame 10 at the neighboring layer. The dislocation angle is between 0 and 360/N degrees except 0 and 360/N degrees, where N is the quantity of the frame at a layer in 360 degrees. Preferably, the dislocation angle is between 40 and 65 degrees. For example, the frames 10 are made of soft magnetic composites (SMC) by a powder metallurgy technique or formed from cutting a silicon steel block.

The multi-layer arrangement may be in three layers in a way that the stator structure generates a three-phase electromagnetic force.

Each of the frames 10 comprises an arc panel 11, at least one main tooth 12, at least one secondary tooth 13, at least one main coil 14 and at least one secondary coil 15.

The arc panels 11 are connected in an encircling arrangement.

The main tooth 12 and the secondary tooth 13 are located at one side of the arc panel 11. For example, assuming that there is one main tooth 12 and two secondary teeth 13, the one main tooth 12 and the two secondary teeth 13 are in a triangular arrangement.

The end face of the above main tooth 12 and secondary tooth 13 may be an arched shape noted as 121 and 131 in FIG. 1.

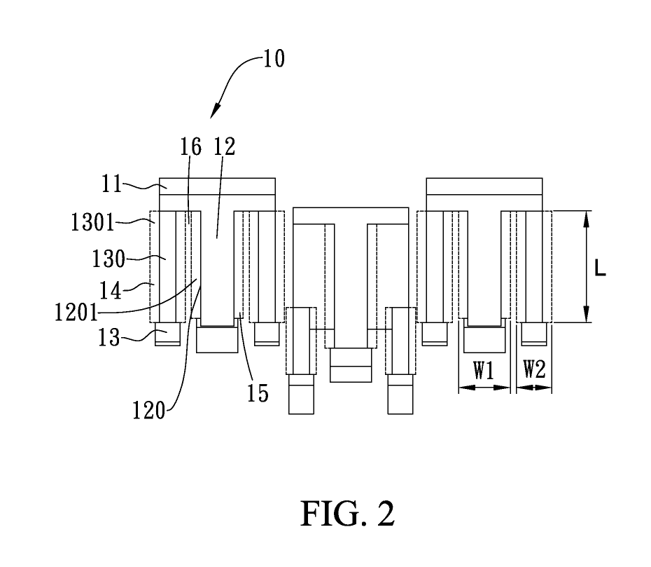

Referring to FIG. 2, the main tooth 12 comprises a main coil portion 120, which has a groove with a depth noted as 1201 in FIG. 2.

The secondary tooth 13 comprises a secondary coil portion 130, which has a groove with a depth noted as 1301 in FIG. 2.

The main body 1 further comprises a plurality of encircling channels 16 located between the frames 10, the secondary teeth 13 and the main teeth 12. The main body 1 further comprises a through hole 17 for penetrating a rotor 2 therein. The rotor 2 comprises a plurality of magnetic coils 20, which are for example, a permanent magnet or other kinds of material or structure with magnetic feature.

The main coil 14 is installed at the main coil portion 120 of the main tooth 12.

The two secondary coils 15 are respectively installed at the secondary coil sections 130 of the two secondary teeth 13, and the main coil 14 of one frame 10 is disposed between the secondary coils 15 between two other frames 10.

For example, the main coil 14 and the two secondary coils are made of SMC by a powder metallurgy technique, or cut from a silicon steel block. The SMC has a low magnetic conductivity and a relative permeability of approximately 500 to 700. As the SMC is processed by power metallurgy, more complex shapes can be achieved such that the SMC may render a shorter flux path via a three-dimensional magnetic circuit structure, thereby yielding a thrust greater than that of a two-dimensional design having a same volume.

The silicon steel plate material features a low iron loss, high magnetic induction strength, high lamination factor, and satisfactory adherence, weldability and magnetic aging properties of a surface with respect to an insulation film. The magnetic aging is an occurrence of changes between magnetism of a magnetic material and the time being used. Hence, since the silicon steel plate material has high magnetic induction strength, a linear motor, stator or rotor manufactured therefrom has a smaller volume and weight for reducing material costs.

The side shape of the main tooth 12 and the secondary tooth 13 may be arc noted as 122 and 132 in FIG. 1, and so a coil length under a same coil-wound area can be reduced for the main coil 14 and the secondary coil 15 installed at the main tooth 12 and the secondary tooth 13, thereby significantly decreasing the amount of copper wires used as well as lowering copper loss for increasing efficiency. Taking the coil area shown in FIG. 2 for example, the main coil 14 has a width W1 and a length L at the main tooth 12, and thus has a coil area of W1×L. Similarly, the secondary coil 15 has a W2 and also the length L at the secondary tooth, and thus has a coil area of W2×L.

Further, grains of the SMC are insulated. With cooperation of the side shape 122 and 132 in arc for main tooth 12 and secondary tooth 13, not only insulation paint of the copper wires can be prevented from falling off, but also insulation costs additionally added during the manufacturing process can be lowered for increasing a coil density. Further, as the grains of the SMC are insulated, eddy currents generated by the flux are restrained among the grains to reduce current loss.

For example, assuming the main coil 120 and the secondary coil 130 are a groove structure and the SMC material is featured by flexibility and properties of a magnetic circuit, a groove area of the main coil 120 and the secondary coil 130 can be increased by 30% to 40%. The increase in the groove area increases the winding turns, so that a greater ampere turns can be provided for a limited current density to yield a larger thrust density.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A stator structure, comprising:
a main body, comprising a plurality of frames, each frame having an arc panel, at least main tooth, at least one secondary tooth, at least one main coil and at least secondary coil; the main tooth and the secondary coil tooth being on one face of the arc panel, the main coil being at the main tooth, and the secondary coil being at the secondary coil;
wherein, a rotor is penetrated through the stator structure, the frames are in a multi-layer circular arrangement, and a dislocation angle is between a frame at any layer and the frame at a neighboring layer.

2. The stator structure according to claim 1, wherein the dislocation angle is between 0 and 360/N degrees except 0 and 360/N degrees, where N is the quantity of the frame at a layer in 360 degrees.

3. The stator structure according to claim 1, wherein the at least one main tooth and the at least one secondary tooth are in a multi-angular arrangement.

4. The stator structure according to claim 1, wherein the end face of the main tooth and the secondary tooth are an arched shape or a plane shaped.

5. The stator structure according to claim 1, wherein the main tooth comprises a main coil section and the main coil is installed at the main coil section; the secondary tooth comprises a secondary coil section, and the secondary coil is installed at the secondary coil section.

6. The stator structure according to claim 5, wherein the main coil section is a groove and the secondary coil section is a groove.

7. The stator structure according to claim 1, wherein the main body further comprises a plurality of encircling channels disposed between the frame, the secondary tooth and the main tooth.

8. The stator structure according to claim 1, wherein the main body further comprises a through hole for penetrating the rotor therein.

9. The stator structure according to claim 1, wherein the multi-layer frames are at least three-layered.

10. The stator structure according to claim 1, wherein the arc panels are connected in an encircling arrangement.
